(19) United States
(12) Patent Application Publication
(10) Pub. No.: US 2010/0033518 A1
(43) Pub. Date: Feb. 11, 2010

(54) LIGHTBOARD

(76) Inventors: ALI SHEKARCHI, Tehran (IR); Gholamreza Chegini, Tehran (IR)

Correspondence Address: BARRY CHOOBIN, TALEGHANI, BAHARE SHOMALI , #219, SUITE#18, TEHRAN, 1563714311, IR

(21) Appl. No.: 12/185,825

(22) Filed: Aug. 5, 2008

(51) Int. Cl. G11B 9/00

(52) U.S. Cl. 346/74.3

(57) ABSTRACT

A Light-board Writing Device for writing and erasing drawing lines or a character on the main surface of a display sheet consisting: of a display sheet having a non-magnetized surface; at least one polymer part; at least one magnetic pin; at least one lamp; and a magnetic pen having to ends. By moving one end of the magnetic pen over the main surface of the display the at least one magnetic pin is displaced and allows the light to pass to form a character or drawing lines on the main surface of the display, and, by moving the other end of the magnetic pen over the main surface of the display the at least one magnetic pin is displaced wherein said at least one pin blocks the passage of the light thereby erasing the character or the drawing lines.

### BACKGROUND OF THE INVENTION

1. Field of the Invention

The present invention relates to a display sheet which is comprised of magnetically materials and illuminating components for writing and erasing, wherein a magnetic pen records and erases recorded characters or drawing lines written on the display sheet.

2. Related Background Art

There isn't any display or board system that records the characters with illumination. However, there has been known a magnetic recording system that a magnetic recording is conducted on the microcapsule magnetophoretic display sheet. Also there has been known the magnetic board that used for writing.

But, the above systems use magnetic powder and are not able to write in colors and lack the ability to erase partially. Furthermore, they fail to satisfy the need for big learning centers.

Therefore, the uses thereof are limited.

### SUMMARY OF THE INVENTION

The Light-board Writing Device as disclosed herein is a new writing board that creates a new revolution in writing. The Light-board Writing Device is a combination of magnetically parts and illumination components that can write and erase characters, diagrams and/or the like on a display sheet. The present invention can be applied to various cases, for example, chalk boards, magnetic boards by attaching it on surfaces of walls, lockers, etc. The present inventors have paid attention to this regard and continued to carry out various investigations. As a result, it has been found that the prior systems for writing boards are improved by the present invention. In the present invention by moving one end of the magnetic pen over the display sheet surface, the magnetic pins are displaced and allow the light to pass to form a character or drawing lines on the main surface of the display, on the other hand, by moving the other end of the magnetic pen over the main surface of the display the magnetic pins are displaced wherein said pins block the passage of the light thereby erasing the character or the drawing lines.

It is therefore a first object of the present invention to provide a Light-board Writing Device, by which characters, diagrams and/or the like are magnetically recorded on a display sheet, wherein said device consists of: a plurality of illumination sources; a plurality of soft plates; a plurality of polymer parts wherein said polymer parts are connected to each other; a plurality of magnetic pins, wherein said pins consists of a first end and a second end, and wherein said second end is attached to said soft plates; a display sheet; a frame and a magnetic pen wherein said magnetic pen consists of a first end for writing and a second end for erasing.

A second object of the present invention is to provide a Light-board Writing Device for writing characters, diagrams and/or the like, by moving a first end of the magnetic pen over the surface of the display sheet.

A third object of the present invention is to provide an erasing mechanism for erasing characters, diagrams and/or the like, by moving a second end of the magnetic pen over the surface of the display sheet.

The above objects of the present invention can be achieved by the respective aspects of the present invention as described below.

According to the present invention, the system does not use any liquid magnetic or microcapsule magnetophoretic for writing and recording characters. On the other hand, the present invention uses narrow steel magnetic pins with diameter of 1 mm.

In the Light-board Writing Device according to the present invention, recording characters, diagrams and/or the like on the display sheet are represented in form of the various visible colors according to the type of the illumination source wherein said representation is independent of environmental illumination.

In the Light-board Writing Device of the present invention the display sheet contains at least 100 polymer parts with hollow center.

The Light-board Writing Device of the present invention contains at least 100 steel magnetic pins with 1 mm in diameter.

In the Light-board Writing Device of the present invention, the illumination source contains 3 to 6 illumination sources which are positioned behind the polymer parts and fixed to the interior parts of the frame.

In the Light-board Writing Device of the present invention, the frame contains all the components of said device. Therefore, the device does not permit emission of any material like chalk, dust or harmful material to environmental.

In the Light-board Writing Device of the present invention, writing and erasing is easy and does not require an extra force.

### BRIEF DESCRIPTION OF THE DRAWINGS

The above and other objects, features and advantages of the present invention will become apparent from the following description and the appended claims, taken in conjunction with the accompanying drawings, in which:

FIG. 1 is a plan view of Light-board Writing Device, illustrating a Light-board Writing Device, a pen and a power cable.

FIG. 2 is a plan of back view of Light-board Writing Device, illustrating 3 lamp and power cable.

FIG. 3 is a plan view of polymer parts, illustrating: magnetic pins (1 and 2); polymer part (3); soft plate (4).

FIG. 4 is a plan view of Light-board Writing Device, illustrating “Lightboard” word, a magnetic pen and power cable.

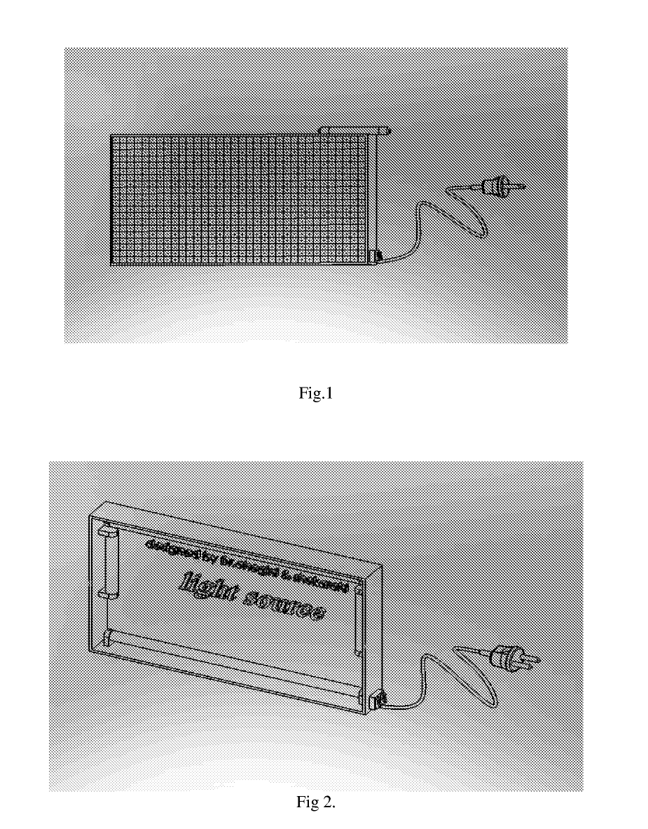

### DETAILED DESCRIPTION OF THE PREFERRED EMBODIMENTS

The present invention will hereinafter be described in detail.

Preferred embodiment of the present invention will be described with reference to the drawings hereafter.

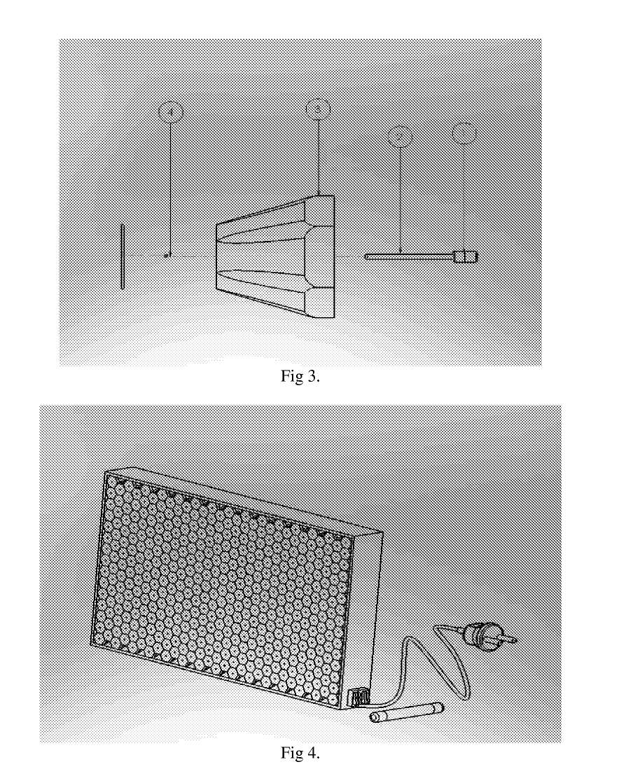

FIG. 3 is a plan view of Light-board Writing Device according to the present invention. A writing device (Lightboard) of the present invention is a magnetically writable and erasable writing device which consists of: a plurality of illumination sources; a plurality of soft plates (4); a plurality of polymer parts (3) wherein said polymer parts are connected to each other; a plurality of magnetic pins (1 and 2), wherein said pins consist of a first end and a second end, and wherein said second end is attached to said soft plates; a display sheet; a frame and a magnetic pen wherein said magnetic pen consists of a first end for writing and a second end for erasing.

In other embodiment, the first end of the magnetic pen causes the first end of magnetic pin be displaced, thereby opening an aperture for passing the illumination light and forming a character based on the shape of the aperture.

In another embodiment, the second end of the magnetic pen causes the first end of the magnetic pin be displaced in reference to previous position of said magnetic pin, thereby blocking the passage of the illumination from the illumination source, resulting in erasing the written character.

In the Light-board Writing Device according to the present invention, the at least 100 polymer parts are hollow and connected to each other and embed the second end of magnetic pin.

The diameter of these polymer parts is preferably not greater than 50 .mm. however; the diameter and the quantity of said polymer parts are modifiable. The magnetic pins move according to movement of magnetic pen. When moving the magnetic pen over the surface of the display sheet, the area corresponding to the polymer parts located below the display sheet where the magnetic pen travels will be subject to displacement of the magnetic pins. When magnetic pins are displace that is, coming forward or being magnetized by magnetic pen the soft plate being attached to the other end of magnetic pin moves forward too. Therefore, an opening is established and the light coming from illumination sources will create a character on the display sheet.

In the Light-board Writing Device described above, the supply of electricity is 220 v and 50 A in current and can be supplied with a battery.

Thus, according to the Light-board Writing Device writing device of the present invention, there is provided an improved writing device, in which no supplement of writing tools and the like is required, hands, clothes and the like being free from stain, the burden of preparing and handling of the referential character model being removed, no extra space being required, embarrass store keeping being removed.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A light-board writing device for writing and erasing characters and line drawings on a display sheet, said light-board writing device consisting of: a plurality of illumination sources; a plurality of soft plates (4); a plurality of polymer parts (3) wherein said polymer parts are connected to each other; a plurality of magnetic pins (1 and 2), wherein said pins consist of a first end and a second end, and wherein said second end is attached to said soft plates; a display sheet; a frame and a magnetic pen wherein said magnetic pen consists of a first end for writing and a second end for erasing.

2. A light-board writing device for writing and erasing characters and line drawings on a display sheet as claimed in claim 1, wherein said first end of the magnetic pen causes said plurality of magnetic pins and said plurality of soft plates to be displaced, thereby opening an aperture for passing the illumination light and forming a character or a line drawing based on the shape of the aperture.

3. A light-board writing device for writing and erasing characters and line drawings on a display sheet as claimed in claim 1, wherein said second end of the magnetic pen causes said plurality of magnetic pins and said plurality of soft plates to be displaced, thereby closing said aperture for passing the illumination light and erasing said character or said line drawing on said display sheet.
